(19) United States
(12) Patent Application Publication
(10) Pub. No.: US 2017/0325419 A1
(43) Pub. Date: Nov. 16, 2017

(54) WATER DISTRIBUTION STATION

(71) Applicant: Deutsche Telekom AG, Bonn (DE)

(72) Inventors: Sebastian Heinz, Bonn (DE); Joerg Windheuser, Duesseldorf (DE); Michael Schmidt-Gabriel, Wessling (DE); Johannes Scholl, Munich (DE)

(21) Appl. No.: 15/525,591

(22) PCT Filed: Nov. 10, 2014
(86) PCT No.: PCT/EP2014/002997

§ 371 Date: May 10, 2017

(51) Int. Cl. A01G 25/16

(52) U.S. Cl. CPC A01G 25/167; A01G 25/165

(57) ABSTRACT

A water distribution station includes: a water inlet; and at least one hose connection, wherein each hose connection is configured to be connected to a hose to conduct water from the water distribution station to at least one location for providing water. The water distribution station is configured to be assembled in modular form from a plurality of water distribution modules, each water distribution module having: at least one water inlet and a hose connection, provided with a controllable valve, for connection to a hose. A supply container is connectable to each water distribution module for receiving nutrients which can be metered from the supply container to the hose connection of the respective water distribution module.

### CROSS-REFERENCE TO RELATED APPLICATIONS

This application is a U.S. National Phase application under 35 U.S.C. §371 of International Application No. PCT/EP2014/002997, filed on Nov. 10, 2014. The International Application was published in German on May 19, 2016, as WO 2016/074688 A1 under PCT Article 21(2).

### FIELD

The invention relates to a water distribution station, in particular for watering gardens and beds, comprising a water inlet and at least one hose connection, preferably at least two hose connections, it being possible to connect a hose to each hose connection to conduct water from the water distribution station to at least one location requiring water.

### BACKGROUND

Water distribution stations are known in the prior art, for example from the company Gardena under the name of “Water Distributor automatic”. A water distribution station of this type is used to divide a supply of water into optionally a plurality of water outflows means, which are configured as a hose connection, in order to supply water to a plurality of locations requiring water. This can be carried out by a parallel operation of optionally the plurality of hose connections or, if the water pressure is inadequate, by a sequential successive operation of optionally the plurality of hose connections, as is the case in the mentioned device.

The aforementioned device is configured, for example, to be operated by a watering computer which is a separate device and which can program watering times for each operated hose connection, although the two devices do not communicate with one another and therefore an assignment of the programming to the individual hose connections can also get lost. Furthermore, the maximum number of operable hose connections is restricted to six and, if the user wants to operate fewer than six connections, the connections which are not being used have to be closed. In a case of this type, a user has to buy an infrastructure which he does not use to its fullest extent, which entails a financial disadvantage.

Furthermore, the known water distributor can merely supply water to different locations requiring water. However, a satisfactory supply of nutrients to a particular location requiring water has to be performed by the user himself. In this respect, it should also be considered a disadvantage that, as a rule, the user does not have sufficient knowledge about the actual nutrient requirement and also that different types of plants have a different requirement of nutrients, in particular of different nutrients, which the user would also have to consider in each case.

### SUMMARY

In an exemplary embodiment, the invention provides a water distribution station. The water distribution station includes: a water inlet; and at least one hose connection, wherein each hose connection is configured to be connected to a hose to conduct water from the water distribution station to at least one location for providing water. The water distribution station is configured to be assembled in modular form from a plurality of water distribution modules, each water distribution module having: at least one water inlet and a hose connection, provided with a controllable valve, for connection to a hose. A supply container is connectable to each water distribution module for receiving nutrients which can be metered from the supply container to the hose connection of the respective water distribution module.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is an overview of a water distribution station according to an exemplary embodiment;

FIG. 2 shows the construction of a water distribution module in more detail;

FIG. 3 shows a sensor element in a location which is to be supplied with water; and

FIG. 4 shows a visualization of a mode of operation.

### DETAILED DESCRIPTION

Exemplary embodiments of the invention provide a water distribution station of the generic type such that, in principle, the number of water outflow means which can be achieved by hose connections is not restricted, and a user can choose any number of water outflow means himself. Furthermore, it may be ensured that, when desired, a different requirement of nutrients can be taken into account at each hose connection configured as a water outflow means.

Exemplary embodiments of the invention may further provide a user with feedback about the condition of the locations requiring water and, more preferably, also while bearing in mind environmental aspects, and to curb water wastage, in an ideal case to restrict water consumption to the bare minimum, in particular in each case in a manner which is individually adapted to a particular location requiring water.

In an exemplary embodiment, the invention provides a water distribution station which can be assembled in modular form from a plurality of water distribution modules, each water distribution module having a water inlet and a hose connection, provided with a controllable valve, preferably an electrically/electronically controllable valve, for connection to a hose, a supply container being connectable to each water distribution module for receiving nutrients, in particular liquid nutrients, which can be metered from the supply container to the hose connection of the relevant water distribution module. In a further exemplary embodiment, the water distribution modules may be identical.

In an exemplary embodiment, the modularity makes it possible to provide only the precise number of hose connections at a water distribution station which a user actually requires. There is thus no need to blind flange unrequired hose connections as in the prior art and thus the costs for unrequired, and yet purchased, connections are also avoided.

According to the invention, each water distribution module provides at least one hose connection so that a hose connection of this type can cover the water requirement at a location requiring water, for example at a specific bed in the garden. Thus, it is only the number of water distribution modules which are to be used and are joined together to form the entire water distribution station which increases with the number of locations requiring water to be supplied. The number of water distribution modules can be individually chosen by the user. The water is supplied to the individual water distribution modules jointly in each case via the water inlet thereof. The water distribution modules can be connected to a central docking station or also interconnected by these water inlets. The water can be supplied such that all the water inlets are pressurized at the same time or successively.

In the case of a simultaneous pressurization of the water inlets of all the water distribution modules, it can be preferably provided that the water distribution modules are each controlled individually (for example by their own individual electronic control system or externally) to let water pass through, i.e. for example the valve-controlled through-connection of the water inlet onto the hose connection, for example, in the simplest case, in a time-controlled manner or in a measured value-controlled or regulated manner according to embodiments described at a later point.

For this purpose, individual water distribution modules can be arranged one behind the other or adjacently. In a preferred embodiment, each water distribution module also has a water outlet for connection to the water inlet of a further water distribution module. In this case, the water inlet and water outlet are preferably located in alignment on opposite housing sides of the water distribution module.

Therefore, according to the invention, the water outlet of a water distribution module can be connected or is connected in each case to the water inlet of the following water distribution module. In this case, of all the interconnected water distribution modules, only one, namely preferably the first water distribution module connected in the water flow direction, has a free unoccupied water inlet which then serves as a central water inlet for all the water distribution modules located therebehind in the flow direction. For this purpose, all the water inlets of the plurality of water distribution modules are preferably fluidically interconnected.

When a docking station is used, it is sufficient if it has a central water inlet and connection points, to which the modules can be connected by their respective water inlets. Here, the control can also be carried out by an electronic system which is integrated in the docking station or by an external controller which controls said electronic system.

Control of the water flow through the at least one hose connection which is respectively provided per water distribution module, for example by activating a controllable valve provided therein, can thus preferably be carried out individually by each water distribution module itself, for example by an electronic control system located therein or by a higher-level controller which is common to a plurality of modules, preferably to all modules, and which can, for example, also be realized in one structural unit to which the individual water distribution modules can each be docked.

A plurality of, in particular structurally identical, water distribution modules are preferably interconnected without a central docking station and at least by one plug-in connection for the water inlet and water outlet of adjacent water distribution modules, i.e. for example by coupling together corresponding connecting pieces of the water inlet and water outlet.

The modules are preferably further coupled together mechanically, for example to prevent the modules from rotating relative to one another if, as is frequently common, connecting pieces of the water inlet and water outlet are configured so as to be rotationally symmetrical. A mechanical connection of this type can be carried out, for example, via the opposite side faces of adjacent water distribution modules, for example by insertion elements and recesses which the insertion elements can penetrate. In this way, a plurality of water distribution modules which are arranged in a row and interconnected can form a cohesive fixed unit. The side faces of water distribution modules can thereby form an interface for the connection of modules of this type, by at least fluidic and preferably also mechanical coupling elements.

In an exemplary embodiment, a supply container may be connected to each water distribution module which is used to receive nutrients, in particular liquid nutrients. These nutrients can be metered into the hose connection of the relevant water distribution module by a metering apparatus, for example by a metering valve in the supply container or also in the water distribution module.

Here, the metered addition can also be controlled by an electronic controller which is provided in each water distribution module or also by a common controller of all the water distribution modules, which in particular, as previously mentioned, can be realized in a single structural unit, to which the individual water distribution modules can each be docked.

Thus, according to the invention it is possible to supply each location requiring water which is assigned a water distribution module with a different nutrient composition or also with other additives, for example also pesticides, based on individual requirements. Thus, for example, a rose bed can be supplied with different substances compared to a vegetable bed, despite the water being supplied to all the locations requiring water through the same water inlet, preferably of one of the water distribution modules.

In order to attach a supply container, each water distribution module can preferably have at/on its upper housing side, and a supply container can preferably have at its lower housing side, mutually matching interfaces which create at least one fluidic connection, preferably also a mechanical connection, between the water distribution module and the supply container. The supply container and the water distribution module can preferably have in horizontal cross section an identical cross-sectional shape and cross-sectional size. As a result, when they are connected, they form in particular a uniform housing appearance.

In this respect, it can be provided that a user himself prepares the nutrient composition or generally the content, and the user himself can fill and also refill a supply container with this composition.

Another embodiment can also provide that, in connection with a system/kit, a water distribution station according to the invention comprises a plurality of supply containers containing premixed, in particular plant-specific, nutrient mixtures, each supply container being in particular labeled in respect of its nutrient mixture or plant type for which the nutrient mixture is intended.

Premixes of this type can be offered in a ready-made form, for example in retail outlets, for example garden centers. In this respect, it can be provided in particular that each supply container of the mentioned plurality can be connected to any water distribution module via a uniform interface. This also applies to any type of supply container, in particular to empty supply containers which can be filled by the user or which remain empty during the operation of a water distribution station, for example when nutrients are not going to be added at any point.

If a supply of nutrients or other agents is not required, it can also be provided that the supply container interface can be connected to a water distribution module, without having to connect a supply container.

A preferred embodiment can provide that the water distribution station has at least one communication module for radio communication with a communication device. In this respect, a common communication module can be provided at the water distribution station, in particular in the power supply thereof, which common communication module is provided for all the water distribution modules, or there is one communication module per water distribution module which in particular can be inserted into a slot of a water distribution module. In the first case, data can thus be communicated to and from the mentioned structural, in particular central, unit of the water distribution station, this unit in particular preparing the data for or from each water distribution module and carrying out the control. In the second case, each individual water distribution module is itself capable of communication and can exchange data, i.e. for example it can receive data for control purposes or it can transmit data, for example measured data, such as the consumption of nutrients, the amount of water flowing therethrough, etc.

A communication module can be integrated in a wide area network, for example it can operate according to a mobile communication standard, for example GSM (Global System for Mobile communication), UMTS (Universal Mobile Telecommunications Service), LTE (Long-Term Evolution), etc. For this, a SIM (subscriber identity module) card of a network operator, for example of the applicant, can be inserted into a communication module. In addition or also exclusively, a communication module can have been or can be integrated in a short range network, for example according to WLAN (wireless local area network) standards, Bluetooth, etc.

The communication device which is in a communication connection with a unit of the water distribution station or with each water distribution module can be a mobile communication device of a user, but it can also be a stationary computer. Thus, a user can access the internal controller of the water distribution station for example, the user being in particular able to intervene in and program the controller and/or retrieve status data and thus find out whether for example nutrients need to be topped up.

For example, this can be carried out via an application which is executable on a smartphone.

Exemplary embodiments of the invention can also provide that each water distribution module can be assigned at least one sensor element which can be introduced into the soil and which can measure soil values, in particular the moisture content and/or the nutrient content of the soil, in a location requiring water, measured values detected by the at least one sensor element being transmittable to a communication device and/or to a water distribution module or to an aforementioned communication module of a water distribution module or of a central unit via a communication connection. In this respect, the water distribution station or the assigned water distribution module can preferably be configured to control the assigned water distribution module on the basis of the measured values from the sensor element.

In this connection, the following actions can be performed which are listed non-exhaustively and by way of example and which can also be combined together as desired:
control of the in particular electronically/electrically controllable water valve of the hose connection of each water distribution module, on the basis of measured values from the sensor element which represent the moisture content of the soil;
control of the in particular electronically/electrically controllable valve of the hose connection of each water distribution module, on the basis of current weather data or weather forecast data, which in particular is read by communication from a weather station and/or a weather database;
control of a metering valve in the water distribution module or in the supply container, on the basis of measured values from the sensor element which represent the nutrient content.

For example, a water saving function can be achieved in that although the sensor element measures a low soil moisture content, which would give reason to carry out watering, it is known from current weather data, in particular from current forecast weather data, or at least a threshold probability is exceeded, that it is going to rain, in particular within a predeterminable time frame. Watering need not then be carried out due to the control, based on local soil moisture data and weather data.

The control can also provide that when measurements have established that there is a lack of nutrients, nutrients are added to the water from the supply container, or nutrients are not added when sufficient nutrients are present in the location of the sensor element.

If it is established by at least one sensor element that there is a lack of nutrients, the invention can also provide that the water distribution station or the assigned water distribution module is configured to carry out watering with added nutrients, even if, when the soil contains a sufficient amount of moisture, watering would not be necessary for moisture reasons. The nutrient supply which is sufficient at any time can thus also be ensured.

Exemplary embodiments of the invention may provide that a sensor element which is assigned to a water distribution module is arranged at least in the local vicinity of the outlet of the hose connected to the water distribution module, so that a watering action and/or supply of nutrients can also be established by this sensor element, particularly in a timely manner.

In an embodiment, a sensor element can be connected to the hose coming out of a water distribution module, in particular via a hose connection, it being possible in particular for water to be conducted thereby to an outlet opening in the insertion element of the sensor element, by which it can be introduced into the soil. In this way, the water is conducted directly to the introduction site of the sensor element. Instead of a hose connection between the sensor element and the hose, the sensor element can also be attached directly to the hose, in particular while establishing a fluid connection, or the hose is connected to the sensor element and the sensor element itself forms the outlet of the hose.

A sensor element can be powered in a self-sufficient manner, for example by a solar cell and battery charged thereby which are integrated in the sensor element. Likewise, a wired external power supply is possible, for example via the water distribution station or an individual water distribution module.

Communication between the sensor element and the water distribution module thereof or a central unit comprising a plurality of water distribution modules can take place via cable or via radio, for example via WLAN, Bluetooth or via a wide area network, in particular GSM, UMTS, LTE, etc., for which the sensor element has a communication unit.

The invention can also provide that a hose which can be connected to a water distribution module has a cable which extends along the extent of the hose and comprises at least one conductor, the cable of the hose or the conductor thereof being electrically contactable with the water distribution module, for example by a plug connection which establishes an electrical connection to the cable in addition to a water-conducting connection. Any signal imprinted electrically there or also at the location of a sensor element can thus be conducted along the entire extent of the hose and can be picked off at any location of the hose.

For example, it can be provided that a power supply of a sensor element is configured or at least can be configured via the cable. Furthermore, a wired communication path is configured or at least can be configured via the cable between the water distribution module and sensor element to communicate measured values. Electrical connections between the sensor element and the cable in/on the hose can take place, for example by piercing contacts, but can also take place inductively. It can also be provided to provide at contacting points, for example at the end thereof or over the length of the hose at periodic intervals at which, for example the sensor element can be connected to the cable. These contacting points can be configured so as to be water-tight.

Furthermore, the water distribution station or each of the water distribution modules thereof or a higher-level controller can preferably be configured to form textual and/or graphic information about current soil conditions in the location of a sensor element and/or textual and/or graphic information about future supply actions to be carried out by a water supply module, on the basis of measured values from a particular sensor element and/or weather data, and to communicate this information to a communication device, in particular for the purpose of visualizing it there.

In this way, a user can be informed at any time about the current condition of his plants and, for example he can display on his smartphone or on a computer previous watering actions, current soil values and also future, in particular automatically planned, watering actions, and if necessary he can intervene in the planning.

It can also be provided that the water distribution station or a particular water distribution module is configured to output warnings to a user, for example severe weather warnings, from weather data, acquired through communication, for example from a weather station or also from a weather database, in order to thus be able to promptly take protective measures, if necessary.

A particular water distribution module arranged in the water distribution station can be controlled, for example in respect of water flow and/or nutrient metering, by a controller in each water distribution module itself. In a case of this type, each module can be controlled autonomously and can thus preferably form a unit capable of communication.

All the water distribution modules can also be controlled by a higher-level unit which is arranged at the location of the water distribution station for example, in particular integrated therein. A unit of this type can form a docking station for example to which the water distribution modules can be connected. In this case, it can be sufficient to configure only this unit so as to be capable of communication, in particular in respect of external communication with a communication device of a user, such as a smartphone.

An embodiment will be described with reference to the following figures.

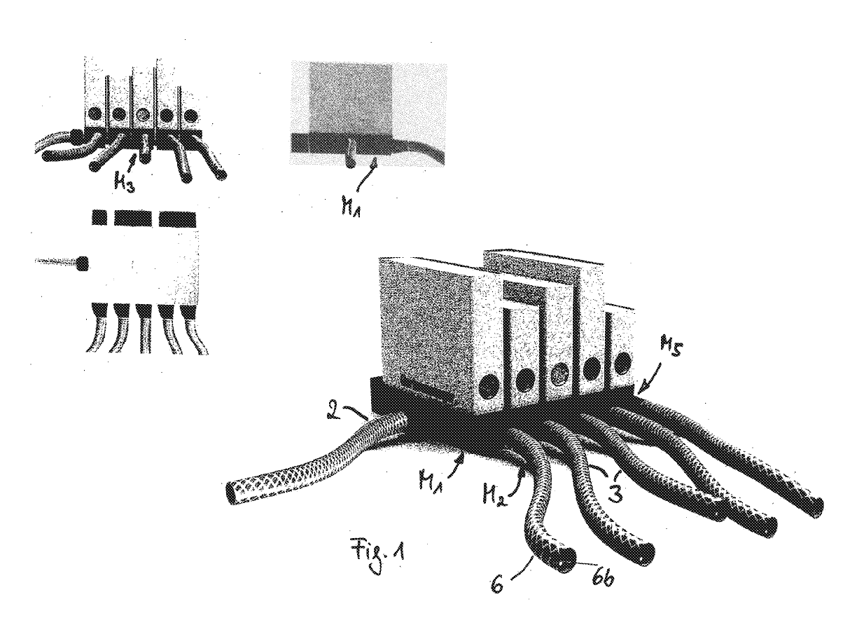

FIG. 1 is an overview of a water distribution station 1 according to an exemplary embodiment of the invention. In this case, the water distribution station 1 is composed of a total of five water distribution modules M1, . . . M5. A water distribution station 1 according to the invention comprises at least one water distribution module, which can be increased in number as desired.

It can be seen that arranged on the left-hand side on the water distribution module M1 is a water inlet 2 which supplies all the modules M1 to M5 with water. Each module has its own controlled or regulated hose connection 3. According to the invention, here the user can decide how many hose connections he requires for watering purposes and accordingly also how many water distribution modules he is going to combine.

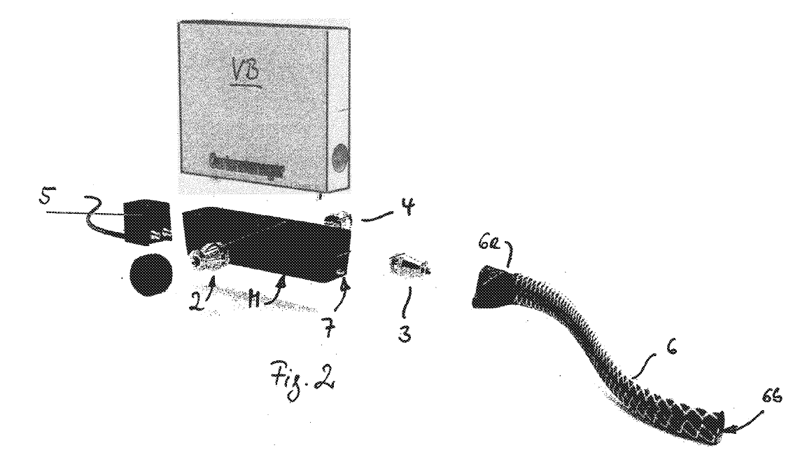

FIG. 2 shows the construction of each of these water distribution modules M1 to M5 in more detail.

Here it can be seen that each module M has a water inlet 2, a hose connection 3 and a water outlet 4. Adjacent modules are connected on the water side in that a water outlet 4 of one module is connected to the water inlet 2 of the following module. In all the embodiments, in general the water inlet 2 and water outlet 4 are preferably opposite one another, in alignment, in particular on opposite side walls, in particular the large side walls, of the module. Here, the hose connection 3 is oriented at an angle of 90 degrees relative to the connection direction between the water inlet and water outlet, in particular on a small side wall of a module.

A communication module 5 can be connected to a module M, in particular also on a small side wall, opposite the hose connection 3. The power supply and communication module 5 can be arranged together in one unit.

Formed on the upper side wall of the water distribution module is an interface to which a supply container can be connected which can receive for example nutrients or other additives, particularly in liquid form. These substances can be metered into the hose connection 3 through the water distribution module. For this purpose, either the supply container or the module M can have a metering unit, in particular a controllable valve.

The hose 6 which can be attached to the hose connection 3 of the water distribution module by a hose coupling 6a comprises a cable 6b which extends along the longitudinal extent of the hose 6, for example on the inside thereof or also on the outside. The at least one conductor of the cable 6b, the sheath of which can be formed by the plastics of the hose, is electrically connected to the module M by the hose coupling 6a on the hose connection 3. For this purpose, in the coupling 6a, the electrical connection is offset radially outwards and can be connected to at least one correspondingly positioned contact 7 on the module M.

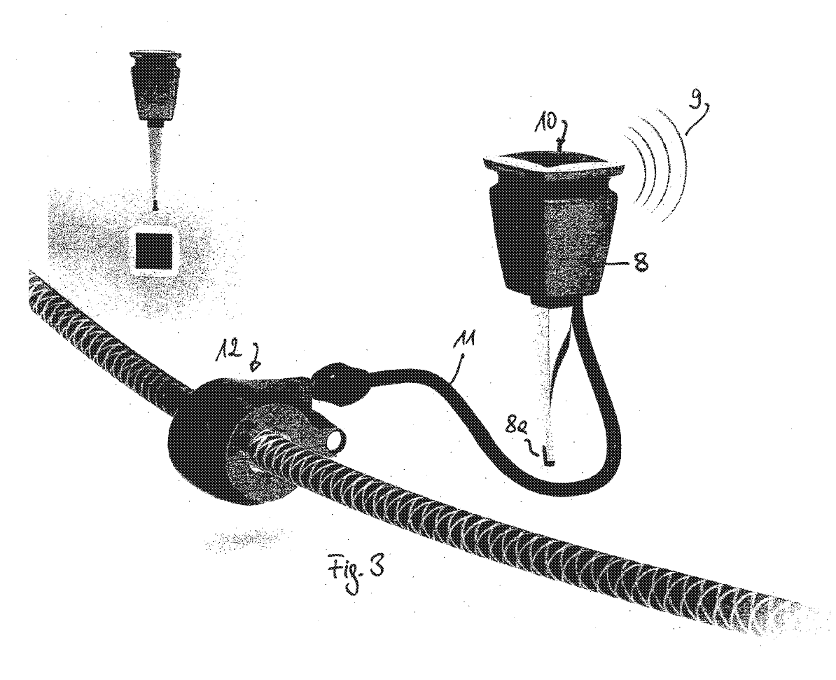

A sensor element 8 can be introduced into the soil in a location which is to be supplied with water, locally removed from the water distribution module, as shown in FIG. 3. This sensor element 8 has, for example, at the lower end 8a of an insertion element, a sensor for soil values, for example moisture and/or nutrients. According to the invention, it is provided to communicate such measured values to the module M or to a higher-level controller, for which purpose in this example the sensor element 8 communicates by radio, indicated by the radio waves 9. Power is supplied by a solar cell 10 and an internal battery.

In this example, the sensor element 8 is connected by a hose connection 11 to the hose 6 which comes from the module M. The end of the hose connection 11 remote from the sensor element 8 has a connector 12 which, in this example, is wrapped around the hose 3 and, in so being, perforates said hose and seals the perforated point. Water from the hose 3 can thereby be fed directly into the sensor element 8 and, for example, can escape at the tip of the insertion element.

If a solar supply is not possible, a power supply for the sensor element 8 can be provided by the cable 6b in the hose. The data from the sensor element can also be transmitted thereby.

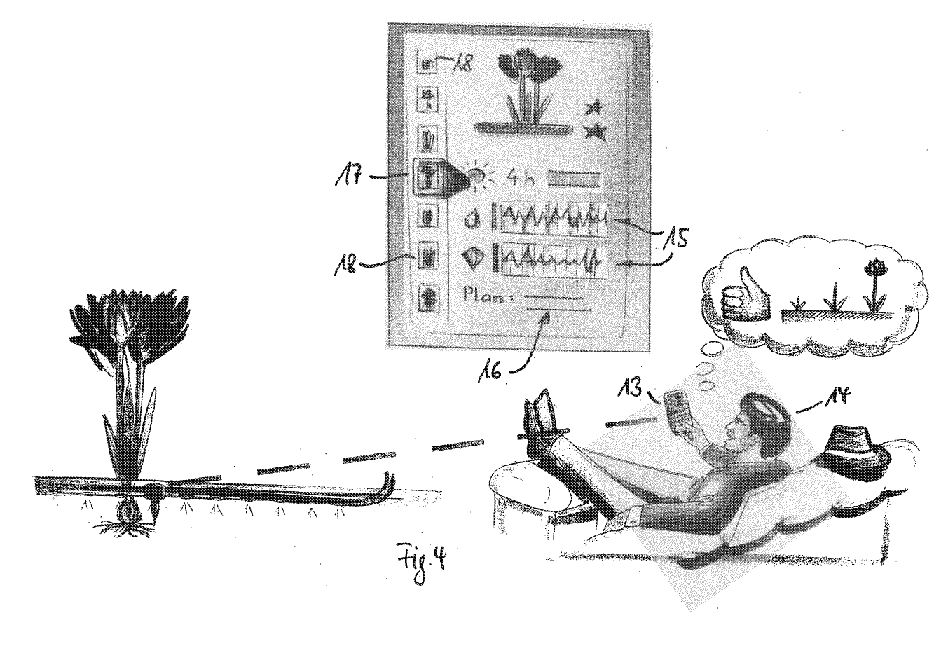

FIG. 4 shows a visualization of the mode of operation. Each water supply module can send the data of an assigned sensor element 8 to a smartphone 13 of a user 14 either by its own communication module 5, or via a communication module common to all the modules M. On his smartphone 14, the user can thereby read off genuine actual values of the watering action and, if appropriate, also values of the nutrients, on the basis of measured values plotted over time in graphs 15.

By loading weather data, it is also possible to prepare and visualize a plan 16 for the future.

The respective data can be formed for each water distribution module M which can be selected for display via the smartphone 13, for example here via the left-hand side pictograms 18 and the slide 17. Each pictogram 18 can be assigned to a module M.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A water distribution station, comprising:
a water inlet; and
at least one hose connection, wherein each hose connection is configured to be connected to a hose to conduct water from the water distribution station to at least one location for providing water;
wherein the water distribution station is configured to be assembled in modular form from a plurality of water distribution modules, each water distribution module having: at least one water inlet and a hose connection, provided with a controllable valve, for connection to a hose:
wherein a supply container is connectable to each water distribution module for receiving nutrients which can be metered from the supply container to the hose connection of the respective water distribution module.

2: The water distribution station according to claim 1, wherein a water distribution module has a water outlet for connection to the water inlet of a further water distribution module.

3: The water distribution station according to claim 1, comprising:
a plurality of supply containers containing premixed nutrient mixtures, each supply container connectable to any water distribution module of the water distribution station via a uniform interface.

4: The water distribution station according to claim 1, comprising:
at least one communication module for radio communication with a communication device, wherein the at least one communication module includes at least one of:
a common communication module at the water distribution station; or
one communication module per water distribution module.

5: The water distribution station according to claim 1, wherein each water distribution module is configured to be assigned at least one sensor element which is configured to be introduced into soil and to measure soil values;
wherein a communication device or the water distribution station is configured to control a respective water distribution module based on measured soil values corresponding to the respective water distribution module.

6: The water distribution station according to claim 5, wherein a valve for each water distribution module is configured to be controlled based on: measured soil values representing moisture content corresponding to the respective water distribution module; and/or weather forecast data; and/or
wherein a metering valve for each water distribution module or supply container is configured. to be controlled based on; measured soil values representing nutrient content corresponding to the respective water distribution module.

7: The water distribution station according to claim 5, wherein a sensor element is configured to be connected to a respective hose coming out of a respective water distribution module via a hose connection; and
wherein the sensor element, comprises an insertion element with an outlet opening configured to introduce water from the respective hose into soil.

8: The water distribution station according to claim 5, wherein a hose configured to be connected to a respective water distribution module has a cable which extends along the extent of the hose and comprises at least, one conductor, the cable of the hose being electrically contactable with a power supply and/or a wired communication path of the water distribution module.

9: The water distribution station according to claim 1, further comprising
a controller configured to form textual and/or graphical information to be displayed in a communication device regarding current soil conditions at a location and/or future supply actions to be carried out by a respective water distribution module.
